(19) United States
(12) Patent Application Publication
(10) Pub. No.: US 2002/0110735 A1
(43) Pub. Date: Aug. 15, 2002

(54) Additive for lithium-ion battery

(76) Inventors: William B. Farnham, Hockessin, DE (US); Feng Gao, Wilmington, DE (US); Lech Wilczek, Wilmington, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 09/739,600

(22) Filed: Dec. 18, 2000

(51) Int. Cl. H01M 10/40; H01M 4/58

(52) U.S. Cl. 429/199; 429/330; 429/231.8

(57) ABSTRACT

Rechargeable lithium or lithium-ion electrochemical cells having unmodified natural or synthetic graphite anodes in contact with propylene carbonate or butylene carbonate electrolyte solvent are enabled by the addition of tetra- or pentafluorobenzenes having electron-donating substituents on the ring. Both reversible fraction and cycle life are favorably affected.

### FIELD OF THE INVENTION

The present invention relates to a novel additive for use in rechargeable lithium or lithium-ion electrochemical cells having graphite electrodes in contact with propylene carbonate to improve capacity retention of the batteries.

### BACKGROUND OF THE INVENTION

Secondary or rechargeable lithium-ion batteries are now under intensive development around the world, as described, for example, in Lithium Ion Batteries: Fundamentals and Performance, ed. M. Wakihara and O. Yamamoto. Weinheim: Wiley-VCH. 1998. The requirements for electrochemical stability are unusually high for the components in secondary lithium ion batteries because the voltages to which they are exposed during charging are generally above 4 volts, highly oxidizing conditions.

In order to be useful in applications such as portable electronic devices, lithium-ion batteries must be compact, light-weight, and safe to operate over a wide range of temperature and charge/discharge conditions, placing considerable further constraints on the component materials. Among the constraints are the cost and availability of suitable materials.

Because of its combination of high capacity and low first cycle loss, graphite is known in the art to be a preferred anode active material in lithium-ion batteries.

It also is well-known in the art that the electrolyte solvents of choice for many embodiments of lithium-ion batteries are mixtures of organic carbonates which include propylene carbonate (PC) or, less preferred, butylene carbonate, as one component. Its relatively low freezing point, low volatility, low viscosity, high dielectric constant, and high electrochemical stability make propylene carbonate a highly desired material for incorporation into the electrolyte solution, often in combination with ethylene carbonate.

Unfortunately, it is further well-known in the art, and demonstrated hereinbelow, that natural and synthetic graphites are subject to attack and exfoliation in the presence of PC during the charging portion of the cycle. The result of this attack sharply increases the first cycle loss of the graphite, and renders the cell virtually useless for its intended purposes.

Despite numerous efforts to replace PC by some other solvent that exhibits similar properties but is more inert to graphite, no solvent inert to graphite has yet been identified which provides all of the many desirable properties of PC. In response to this problem, certain modified graphites have been developed which are far less susceptible to attack by PC. However, such modified graphites are more expensive to produce, the capacity of the graphite is reduced, and they are more subject to supply limitations than the unmodified natural or synthetic graphites which are widely available throughout the world at low prices. Furthermore, even the modified graphites may be susceptible to some degradation by PC.

I. Kuribayashi et. al., Journal of Power Sources, 54, 1-5 (1995), disclose a coating of a pyrolyzed phenol resin on natural or synthetic graphite to produce a coke surface on a graphite core.

Yoshio et al, J. Electrochem. Soc., 147, (4) 1245-1250 (2000) disclose carbon coated graphites by application of the so-called thermal vapor deposition of toluene vapor on to the surface of natural graphite at 1000° C. Graphite specimens having 8.6-17.6 weight % carbon coatings were produced. Fully lithiated specimens were analyzed using Li⁷-NMR establishing that % carbon could be determined directly from the ratio of the integrated peak intensity of the lithium-coke peak located at a chemical shift of 10-16 ppm to that of the integrated peak intensity of the lithium graphite peak at a chemical shift of 40-45 ppm. The higher the concentration of PC in the electrolyte, the greater the first cycle loss. Specimens having 8.6% carbon, showed little or no improvement in first cycle loss over the uncoated graphite controls.

An alternative approach to the problem has been to find additives which inhibit the attack of PC on graphite. However, only few such additives are available, creating yet one more limiting factor in cell design. Furthermore, the lithium-ion cells incorporating the few additives known in the art, while exhibiting dramatically reduced first cycle loss, also exhibit low cycle life.

Hamamoto et al, JP H11-329490, discloses improved lithium ion cells incorporating cyclic carbonates, especially ethylene and propylene carbonate, and a graphite anode with addition of an additive comprising pentafluorobenzene having an additional electron-withdrawing substituent that is not fluorine in the sixth position on the ring.

Shimizu, U.S. Pat. No. 5,709,968, discloses over-charge protected lithium-ion cells combining carbonaceous anodes, propylene carbonate, and halogenated benzenes having electron-donating substituents on the ring. According to Shimizu's invention, preferred species include the use of amorphous carbon coke anodes and halogenated benzenes having few or no fluorines.

Because of the manifold and complex requirements of a lithium-ion cell, it is of considerable benefit to the practitioner to have the greatest possible range of available materials from which to choose in order to optimize design for a particular practical application. It is also of great importance to achieve the highest possible cycle life with high capacity retention.

### SUMMARY OF THE INVENTION

The present invention provides for a rechargeable lithium or lithium-ion electrochemical cell comprising a cathode; a lithium-ion—permeable separator; an anode comprising unmodified natural or synthetic graphite; and an electrolyte solution comprising propylene carbonate or butylene carbonate contacting said anode, the electrolyte solution further comprising an electrolyte salt comprising lithium cations, the electrolyte solution further comprising a fluorobenzene composition represented by the formula

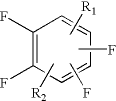

wherein R₁ and R₂ are independently hydrogen, halogen or other electron-withdrawing group, or an electron-donating group with the proviso that if R₁ is a non-halogen electron withdrawing group then R₂ must be an electron-donating group, said electrolyte solution and said electrodes being in ionically conductive contact with each other.

### BRIEF DESCRIPTION OF DRAWINGS

FIG. 1 shows a lithium ion battery in one preferred embodiment of the present invention.

FIG. 2 is a diagram of the coin cell used in performing the evaluations in the specific embodiments herein.

### DETAILED DESCRIPTION

For the purposes of the present invention, the term “reversible fraction” is used herein to refer to a performance metric similar to but not the same as “first cycle loss,” the customary term of the art. Reversible fraction is defined slightly differently depending upon whether or not the cell in question, when first assembled, is in the charged or discharged state. When the cell is assembled in the charged state, as when lithium metal is the anode and carbon is the cathode, the reversible fraction is defined to be the ratio of the capacity recovered upon the first re-charge to the capacity realized upon the first discharge from the initially charged state. When the cell is assembled in the discharged state, as in the case of a LiCoO₂ cathode and a graphite anode, the reversible fraction is defined as the ratio of the capacity realized upon the first discharge to the capacity realized in the first charge from the initially discharged state. In each situation, reversible fraction is the ratio of the capacity realized in the second half of the first cycle to the capacity realized in the first half of the first cycle.

The present invention relates to improved lithium-ion secondary cells or batteries. The practice of the present invention extends the scope of additives which permit secondary lithium-ion cells having high reversible fraction to be assembled with anodes made from unmodified natural or synthetic graphite, and electrolyte solvents comprising propylene carbonate. For the purposes of this invention, high reversible fraction, expressed as a percentage, means at least 70%, preferably at least 80%. In a surprising departure from the teachings of Hamamoto et al, op. cit., which direct the pracititioner to fluorinated benzenes having non-halogen electron withdrawing substituents, it is found in the practice of the present invention that incorporation of tetra- or penta-fluoro benzenes having only halogen or electron-donating substituents, or no additional substitutents at all, into the cell provides comparable or greater benefits.

In one aspect of the present invention, it is found that certain electron donating groups, namely alkyl and alkoxy, impart surprisingly high cycle life compared to electron-withdrawing groups or some other electron-donating groups.

The secondary or rechargeable lithium-ion cells of the present invention are similar in form and function to those described in considerable detail in the art. The cells of the present invention comprise an anode, a cathode, an ionic electrolyte having a lithium cation, a solvent for the electrolyte, a separator, disposed between the anode and the cathode, which permits the passage of lithium ions, and a means for connecting the cell, preferably via current collectors, to an external load or charging means, while the electrolyte solution and electrodes must be in ionically conductive contact with each other.

In the present invention, a secondary or rechargeable lithium-ion cell is assembled according to means well-known in the art. According to the present invention, the anode utilizes unmodified graphite as the lithium-intercalateable material. Further, according to the present invention, the electrolyte solution comprises propylene carbonate or butylene carbonate and 3-20% by weight of a fluorobenzene composition represented by the formula

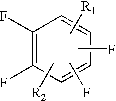

wherein R₁ and R₂ are independently hydrogen, halogen or other electron-withdrawing group, or an electron-donating group with the proviso that if R₁ is a non-halogen electron withdrawing group then R₂ must be an electron-donating group. Preferably R₁ is fluorine and R₂ is alkyl or alkoxy, most preferably R₂ is methyl or methoxy. The preferred concentration of the substituted fluorobenzene is in the range of 4-10% by weight of the electrolyte solution. Preferably the electrolyte solution comprises propylene carbonate.

In general, one of skill in the art will understand which functional groups are electron-donating and electron-withdrawing. Guidance in this regard can be obtained by consulting such standard organic synthesis reference books as Exploring QSAR, Hydrophobic, Electronic, and Steric Constants, C. Hansch, A. Leo, D. Hoekman; ACS Professional Reference Book, ACS, Washington, D.C., 1995. This reference provides, among other parameters, values for the parameter so called “sigma sub P” (σp) for many functional groups. Electron donating groups preferred for the practice of the present invention are those for which σ_{p<}0. More preferably, the selected group will exhibit a σₚ of<-0.1. Suitable electron-donating substituents for the practice of the present invention include alkyl, alkoxy, trialkyl silane, trialkyl siloxy, and dialkylamine. Preferred are alkyl and alkoxy, with methyl, methoxy, ethyl, and ethoxy most preferred.

It is found in the practice of the present invention, as shown in the specific embodiments recited below, that the operability of the present invention can be compromised by undesirable side reaction of the additive of the invention with various possible contaminants present in the cell, with the graphite itself a particularly likely source of contamination. Thus in particular, it has been found in the practice of the present invention that pentafluorophenyltrimethylsilane, a highly reactive additive, was effective in cells containing one type of natural graphite, D-PCG, but completely ineffective in a second type, LBG-80. Thus, those species which are otherwise suitable for the practice of the present invention but which are highly reactive are less preferred in the practice of the invention. (See for example, Comprehensive Organometallic Chemistry, ed. G. Wilkins, Pergamon Press, 1982, pp. 47 and 59; or, Silicon Reagents for Organic Synthesis, ed. W. Weber, 1983, pp. 114 and 123).

The specific components comprising a lithium-ion cell are very well documented in the art. Any form of graphite is suitable for use in the anode composition in the present invention, including those specifically modified to be resistant to exfoliation by PC. However, the greatest benefit of the present invention is realized by utilizing unmodified natural or synthetic graphite with reversible lithium intercalation capacity of 300 mAh/g or greater. For the purpose of the present invention the term “unmodified”, as applied to the graphites preferred for the practice of the invention, refers to the absence of any specific additional treatment step in the preparation thereof intended to modify the surface structure in order to make the resulting modified graphite more resistant to exfoliation by propylene carbonate than the unmodified graphite. For the purpose of the present invention unmodified graphite is natural or synthetic graphite having less than ca. 5 weight percent amorphous carbon.

The graphites suitable for use in the present invention may conveniently be selected according to the reversible capacity and the % carbon in the graphite. Reversible capacity is readily determined according to a method well-known in the art wherein an anode film cast from a dispersion is tested against Li metal utilizing an electrolyte solution of 1 M LiPF₆ in a mixture of ethylene carbonate and dimethyl carbonate (2:1 or 1:1 by weight typically) at a slow charge/discharge of ca. C/10 rate. “C/10” is a term of art which indicates that the full charge or discharge is accomplished in 10 hours. For all practical purposes, any unmodified natural or synthetic graphite, such as are widely available commercially, are suitable.

The percent of amorphous carbon in the graphite may be determined according to the method of Yoshio et al, op.cit. In Yoshio et al, the test specimen is first fully lithiated in a 1 M solution of LiPF₆ in a 1:2 by volume mixture of ethylene carbonate and dimethyl carbonate by incorporating the test specimen as the cathode in a cell having a lithium metal anode and discharging the cell at a current density of 0.4 mA/cm² to 5 mV and holding the cell at this potential for ca. 5 hours. Then the cells are disassembled in an inert atmosphere, washed in dimethylcarbonate (DMC), then dried and subject to vacuum at room temperature for ca. 3 hours in an inert atmosphere. The resulting samples are then scraped off the copper foil substrate upon which they were deposited and sealed in NMR tubes. The tubes are then analyzed in a ⁷Li-NMR spectrometer with a magnetic field of 7.05 T at a resonance frequency of 116.7 MHz. Aqueous lithium chloride is the external standard. Other methods may be employed for fully lithiating the specimen and performing NMR analysis thereon. The ratio of the integrated peak intensity at the lithium-coke chemical shift of 10-16 ppm to the integrated peak intensity at the lithium-graphite chemical shift of 40-45 ppm provides the percentage of amorphous carbon, primarily in the form of surface coke, to the graphite. Graphites having less than 5% amorphous carbon are suitable for the practice of the present invention. Samples having the least amorphous carbon are preferred.

Preferred graphites include purified natural graphites such as BG series and LBG series of graphite flakes supplied by Superior Graphite Corporation (Ill., USA), synthetic graphites such as SFG series, KS series, and SLM series graphites supplied by TIMCAL America Inc. (Ohio, USA), and pyrolyzed carbon fibers having a well developed graphitic structure such as Melblon Milled Fiber supplied by Petoca, Ltd. (Ibaraki, Japan). Unlike SFG graphite, the morphology of PCF's are often dictated by their fibrous precursor and are often cylindrical in shape. Most preferred for the practice of the present invention are Osaka D-PCG (Osaka Gas Co., Ltd, Osaka, Japan) and Superior LBG-80 (Superior Graphite Corporation, Ill., USA).

In the practice of the invention, the anode is preferably formulated by combining the graphite, a binder, preferably a polymeric binder, optionally an electron conductive additive, and a mixture of aprotic solvents comprising propylene carbonate as a component and a fluorobenzene composition represented by the formula

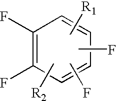

wherein R₁ and R₂ are independently hydrogen, halogen or other electron-withdrawing group, or an electron-donating group with the proviso that if R₁ is a non-halogen electron withdrawing group then R₂ must be an electron-donating group. Preferably R₁ is fluorine and R₂ is alkyl or alkoxy, most preferably R₂ is methyl or methoxy. The preferred concentration of the substituted fluorobenzene is in the range of 4-10% by weight of the electrolyte solution.

The preferred electrolyte solvent of the present invention comprises a mixture of aprotic solvents of which propylene carbonate(PC) or butylene carbonate(BC) is one component. In the practice of the present invention the concentration of propylene carbonate or butylene carbonate falls within the range of 10 to 90 percent by weight. It is possible to use PC or BC alone. PC or BC are most preferably used in combination with ethylene carbonate (EC) because of the high dielectric constant of EC. Preferably the aprotic solvent mixture is a mixture of ethylene carbonate and 35 to 65 by weight propylene carbonate. Other solvents suitable for use in combination with PC include dimethyl carbonate, diethyl carbonate, dipropyl carbonate, ethylmethyl carbonate, methylpropyl carbonate, methyl isopropyl carbonate, methylbutyl carbonate, ethylpropyl carbonate, ethyl isopropyl carbonate, ethylbutyl carbonate, butylene carbonate, vinylene carbonate, esters, diesters and related species.

The electrolyte solution of the present invention further contains 3-20%, preferably 4-10%, by weight of the electrolyte solution, of a fluorobenzene composition represented by the formula

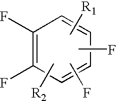

wherein R₁ and R₂ are independently hydrogen, halogen or other electron-withdrawing group, or an electron-donating group with the proviso that if R₁ is a non-halogen electron withdrawing group then R₂ must be an electron-donating group. Preferably R₁ is fluorine, and R₂ is alkyl or alkoxy, most preferably R₂ is methyl or methoxy. In the preferred embodiment, the subsituted fluorobenzene composition is readily soluble at the required concentrations in the aprotic solvents employed in the practice of the invention.

The term “electrolyte solution” encompasses the substituted fluorobenzene composition of the invention as well as the electrolyte solvents and electrolyte salt. The term “electrolyte solvent” refers specifically to those aprotic solvents, such as the preferred organic carbonates, which are employed to provide ionic mobility in the cell formed according to the teachings herein.

In a preferred method, the ingredients are slurried together at room temperature to form an ink or paste. Mixing of the ingredients can be achieved by any convenient means. It has been found satisfactory in the practice of the present invention to prepare the electrolyte solution by combining propylene carbonate or butylene carbonate with such other aprotic electrolyte solvents as are desired, and in proportions ranging from 10 to 90 percent by weight. The electrolyte salt is then dissolved therewithin, followed by, dissolution of the substituted fluorobenzene composition of the invention. There is no particular order of mixing of the ingredients.

In most embodiments, the fluorobenzene composition is a liquid at room temperature, and readily dissolves in the electrolyte solution at a concentration of 3-20%, preferably 4-10%, by weight.

Suitable conductive additives for the anode composition include carbons such as coke, carbon black, carbon fibers, and natural graphite, metallic flake or particles of copper, stainless steel, nickel or other relatively inert metals, conductive metal oxides such as titanium oxides or ruthenium oxides, or electronically-conductive polymers such as polyaniline or polypyrrole. Preferred are carbon blacks with relative surface area below ca. 100 m²/g such as Super P and Super S carbon blacks available from MMM Carbon in Belgium.

In fabricating the cell of the invention the anode may be formed by mixing and forming a composition comprising, by weight, 1-20%, preferably 3-10%, of a polymer binder, 10-50%, preferably 14-28%, of a plasicizing liquid which may be one or more electrolyte solvents, the electrolyte solution of the invention, or an extractable plasticizer such as dibutyl phthalate, and 40-80%, preferably 60-70%, of one or more unmodified natural or synthetic graphites having a reversible lithium intercalation capacity of at least 300 mAh/g, and 0-5%, preferably 1-4%, of a conductive additive. Optionally, up to 12% of an inert filler may also be added, along with other adjuvants which do not substantively affect the achievement of the desirable results of the present invention. It is preferred that no inert filler be used.

The cell preferred for the practice of the present invention utilizes cathodes with an upper charging voltage of 3.5-4.5 volts versus a Li/Li⁺reference electrode. The upper charging voltage is the maximum voltage to which the cathode may be charged at a low rate of charge and with significant reversible storage capacity. However, cells utilizing cathodes with upper charging voltages from 3-5 volts versus a Li/Li⁺reference electrode are also suitable.

Compositions suitable for use as an electrode-active material in the cathode composition include transition metal oxides, phosphates and sulfates, and lithiated transition metal oxides, phosphates and sulfates. Preferred are oxides such as LiCoO₂, spinel LiMn₂O₄, chromium-doped spinel lithium manganese oxides LiₓCr_{y}Mn₂O₄, layered LiMnO₂, LiNiO₂, LiNiₓCo₁₋ₓO₂ where x is 0<x<1, with a preferred range of 0.5<x<0.95, and vanadium oxides such as LiV₂O₅, LiV₆O₁₃, or the foregoing compounds modified in that the compositions thereof are nonstoichiometric, disordered, amorphous, overlithiated, or underlithiated forms such as are known in the art. The suitable cathode-active compounds may be further modified by doping with less than 5% of divalent or trivalent metallic cations such as Fe²⁺, Ti²⁺, Zn²⁺, Ni²⁺, Co²⁺, Cu²⁺, Mg²⁺, Cr³⁺, Fe³⁺, Al³⁺, Ni³⁺, Co³⁺, or Mn³⁺, and the like. Other cathode active materials suitable for the cathode composition include lithium insertion compounds with olivine structure such as LiFePO₄ and with NASICON structures such as LiFeTi(SO₄)₃, or those disclosed by J. B. Goodenough in Lithium Ion Batteries (Wiley-VCH press, Edited by M. Wasihara and O. Yamamoto). Particle size of the cathode active material should range from about 1 to 100 microns. Preferred are transition metal oxides such as LiCoO₂, LiMn₂O₄, LiNiO₂, and their derivatives as hereinabove described. LiCoO₂ is most preferred.

In forming an electrochemical cell of the invention, a cathode is formed by mixing and forming a composition comprising, by weight, 2-15%, preferably 4-12%, of a polymer binder, 10-50%, preferably 15-25%, of a plasicizing liquid which may be one or more electrolyte solvents, the electrolyte solution of the invention, or an extractable plasticizer such as dibutyl phthalate, 40-85%, preferably 60-75%, of an electrode-active material, and 1-12%, preferably 4-8%, of a conductive additive. Optionally, up to 12% of an inert filler may also be added, along with other adjuvants which do not substantively affect the achievement of the desirable results of the present invention. It is preferred that no inert filler be used.

The conductive additives suitable for use in the process of making a cathode are the same as those employed in making the anode as hereinabove described. As in the case of the anode, a highly preferred electron conductive aid is carbon black, particularly one of surface area less than ca. 100 m²/g, most preferably Super P carbon black, available from the MMM S.A. Carbon, Brussels, Belgium.

In a preferred embodiment, the graphite in the anode comprises one or more unmodified natural or synthetic graphites having a reversible lithium intercalation capacity of at least 300 mAh/g, and LiCoO₂ is the cathode active material, the resulting cell having a cathode with an upper charging voltage of approximately 4.2 V versus a Li/Li⁺reference electrode.

The Li-ion cell preferred for the present invention may be assembled according to any method known in the art. In a first method in the art, exemplified by Nagamine et al. in U.S. Pat. No. 5,246,796, electrodes are solvent-cast onto current collectors, the collector/electrode tapes are spirally wound along with microporous polyolefin separator films to make a cylindrical roll, the winding placed into a metallic cell case, and the nonaqueous electrolyte solution impregnated into the wound cell.

In a second, preferred, method in the art, exemplified by Oliver et al. in U.S. Pat. No. 5,688,293 and Venuogopal et al. in U.S. Pat. No. 5,837,015, electrodes are solvent-cast onto current collectors and dried, the electrolyte and a polymeric gelling agent are coated onto the separators and/or the electrodes, the separators are laminated to, or brought in contact with, the collector/electrode tapes to make a cell subassembly, the cell subassemblies are then cut and stacked, or folded, or wound, then placed into a foil-laminate package, and finally heat treated to gel the electrolyte.

In a third, preferred, method in the art provided by Gozdz et al. in U.S. Pat. No. 5,456,000 and U.S. Pat. No. 5,540,741, electrodes and separators are solvent cast with also the addition of a plasticizer; the electrodes, mesh current collectors, electrodes and separators are laminated together to make a cell subassembly, the plasticizer is extracted using a volatile solvent, the subassembly is dried, then by contacting the subassembly with electrolyte the void space left by extraction of the plasticizer is filled with electrolyte to yield an activated cell, the subassembly(s) are optionally stacked, folded, or wound, and finally the cell is packaged in a foil laminate package.

In a fourth method in the art, described in copending U.S. patent application Ser. No. 09/383,129, the electrode and separator materials are dried first, then combined with the salt and electrolyte solvent to make active compositions; by melt processing the electrodes and separator compositions are formed into films, the films are laminated to produce a cell subassembly, the subassembly(s) are stacked, folded, or wound and then packaged in a foil-laminate container.

It is generally preferred to incorporate current collectors as a separate component by which the cell is connected to an electrical load or charging means. The cathode current collector suitable for the lithium or lithium-ion battery of the present invention comprises an aluminum foil or mesh, or a graphite sheet or foil. The anode current collector is preferably a copper foil or mesh. In both anode and cathode it may be advantageous to employ an adhesion promoter between the current collector and the electrode. Of course for optimum operation, it is desirable to minimize the contact resistance between electrode and associated current collector following the practices of the art.

The operability of the present invention does not require the incorporation into the electrode composition of a binder. However, it is preferred in the art to employ a binder, particularly a polymeric binder, and it is preferred in the practice of the present invention as well. One of skill in the art will appreciate that many of the polymeric materials recited below as suitable for use as binders will also be useful for forming ion-permeable separator membranes suitable for use in the lithium or lithium-ion battery of the invention.

Suitable binders include, but are not limited to, polymeric binders, particularly gelled polymer electrolytes comprising polyacrylonitrile, poly(methylmethacrylate), poly(vinyl chloride), and polyvinylidene fluoride and copolymers thereof. Also, included are solid polymer electrolytes such as polyether-salt based electrolytes including poly(ethylene oxide)(PEO) and its derivatives, poly(propylene oxide) (PPO) and its derivatives, and poly(organophosphazenes) with ethyleneoxy or other side groups. Other suitable binders include fluorinated ionomers comprising partially or fully fluorinated polymer backbones, and having pendant groups comprising fluorinated sulfonate, imide, or methide lithium salts. Preferred binders include polyvinylidene fluoride and copolymers thereof with hexafluoropropylene, tetrafluoroethylene, fluorovinyl ethers, such as perfluoromethyl, perfluoroethyl, or perfluoropropyl vinyl ethers; and ionomers comprising monomer units of polyvinylidene fluoride and monomer units comprising pendant groups comprising fluorinated carboxylate, sulfonate, imide, or methide lithium salts.

Gelled polymer electrolytes are formed by combining the polymeric binder with a compatible suitable aprotic polar solvent and, where applicable, the electrolyte salt.

PEO and PPO-based polymeric binders can be used without solvents. Without solvents, they become solid polymer electrolytes which may offer advantages in safety and cycle life under some circumstances.

Other suitable binders include so-called “salt-in-polymer” compositions comprising polymers having greater than 50% by weight of one or more salts. See, for example, M. Forsyth et al, “Solid State Ionics,” 113, pp 161-163 (1998).

Also included as binders are glassy solid polymer electrolytes, which are similar to the “salt-in-polymer” compositions except that the polymer is present in use at a temperature below its glass transition temperature and the salt concentrations are ca. 30% by weight.

Preferably, the volume fraction of the preferred binder in the finished electrode is between 4 and 40%.

The electrolyte solution of the invention comprises propylene carbonate or butylene carbonate, or a combination thereof, as electrolyte solvents. Additional electrolyte solvents which may be used in combination with propylene carbonate or butylene carbonate, or a combination thereof, include aprotic liquids or polymers. Preferred additional electrolyte solvents are organic carbonates such as are known in the art for use in Li-ion batteries, including ethylene carbonate, dimethyl carbonate, diethyl carbonate, dipropyl carbonate, ethylmethyl carbonate, methylpropyl carbonate, methyl isopropyl carbonate, methylbutyl carbonate, ethylpropyl carbonate, ethyl isopropyl carbonate, ethylbutyl carbonate, vinylene carbonate, and many related species. Most preferred in the practice of the present invention is a mixture of ethylene carbonate and propylene carbonate in a ratio of from 2:1 to 1:2.

The electrolyte solution suitable for the practice of the invention is formed by combining one or more lithium salts with the electrolyte solvent or solvents by dissolving, slurrying or melt mixing, as appropriate to the particular materials. Suitable salts include LiPF₆, LiPFₙR_{fm} where n+m=6 and R_{f}=CF₃ or C₂F₅, LiBF₄, LiAsF₆, LiClO₄, or a lithium imide or methide salt.

The concentration of the salt is in the range of 0.2 to up to 3 molar, but 0.5 to 2 molar is preferred, with 0.8 to 1.2 molar most preferred. Depending on the fabrication method of the cell, the electrolyte solution may be added to the cell after winding or lamination to form the cell structure, or it may be introduced into the electrode or separator compositions before the final cell assembly.

The separator suitable for the lithium or lithium-ion battery of the present invention is any ion-permeable shaped article, preferably in the form of a thin film or sheet. Such separator may be a microporous film such as a microporous polypropylene, polyethylene, polytetrafluoroethylene and layered structures thereof. Suitable separators also include swellable polymers such as polyvinylidene fluoride and copolymers thereof. Other suitable separators include those known in the art of gelled polymer electrolytes such as poly(methyl methacrylate) and poly(vinyl chloride). Also suitable are polyethers such as poly(ethylene oxide) and poly(propylene oxide). Preferable are microporous polyolefin separators, separators comprising copolymers of vinylidene fluoride with hexafluoropropylene, perfluoromethyl vinyl ether, perfluoroethyl vinyl ether, or perfluoropropyl vinyl ether, including combinations thereof, or fluorinated ionomers, such as those described in Doyle et al., U.S. Pat. No. 6,025,092, an ionomer comprising a backbone of monomer units derived from vinylidene fluoride and a perfluoroalkenyl monomer having an ionic pendant group represented by the formula:

—(O—CF₂CFR)ₐO—CF₂(CFR′)_{b}SO₃—Li⁺

wherein R and R′ are independently selected from F, Cl or a perfluorinated alkyl group having 1 to 10 carbon atoms, a=0, 1 or 2, b=0 to 6, and the imide and methide derivatives thereof as described in Feiring et al., WO 9945048(A1).

In the electrode suitable for use in the practice of the invention, the most preferred binders are polyvinylidene fluoride (PVDF) or a copolymer of polyvinylidene fluoride and hexafluoropropylene (p(VdF-HFP)) such as that available commercially under the trade name KYNAR FLEX® available from Elf Atochem North America, Philadelphia, Pa. The electrode of the invention may conveniently be made by dissolution of all polymeric components into a common solvent and mixing together with the carbon black particles and electrode active particles. For example, a preferred lithium battery electrode can be fabricated by dissolving PVDF in 1-methyl-2-pyrrolidinone or p(VdF-HFP) copolymer in acetone solvent, followed by addition of particles of electrode active material and carbon black, followed by deposition of a film on a substrate and drying. The resultant preferred electrode will comprise electrode active material, conductive carbon black, and polymer. This electrode can then be cast from solution onto a suitable support such as a glass plate or a current collector, and formed into a film using techniques well-known in the art.

In a preferred embodiment, the electrode films thus produced are then combined by lamination with the current collectors and separator. In order to ensure that the components so laminated or otherwise combined are in excellent ionically conductive contact with one another, the components are combined with the electrolyte solution of the present invention.

The particular method by which the layers comprising a complete cell or battery of the present invention are assembled into the final working battery or cell are not critical for practice of the present invention. A wide diversity of methods for assembling batteries, including lithium and lithium-ion batteries have been disclosed in the art and are outlined above. For the purposes of the present invention, any such method which is compatible with the particular chemical and mechanical requisites of a given embodiment of the present environment is suitable. As noted hereinbelow with respect to the specific embodiments provided, great care must be exercised to avoid the introduction of the performance-destroying defects.

Preferred is the method of Gozdz et al. in U.S. Pat. Nos. 5,456,000 and 5,540,741, wherein a plasticized composition is cast and formed, the plasticizer extracted and the electrolyte added to the dry cell structure. More preferred is to fabricate a cell according to the steps of the process described in Barton et al. copending U.S. patent application Ser. No. 09/383,129, wherein the activated electrode material is melt processed, most preferably by continuous extrusion, into the form of a sheet and is laminated to the other components of the battery in a single continuous operation.

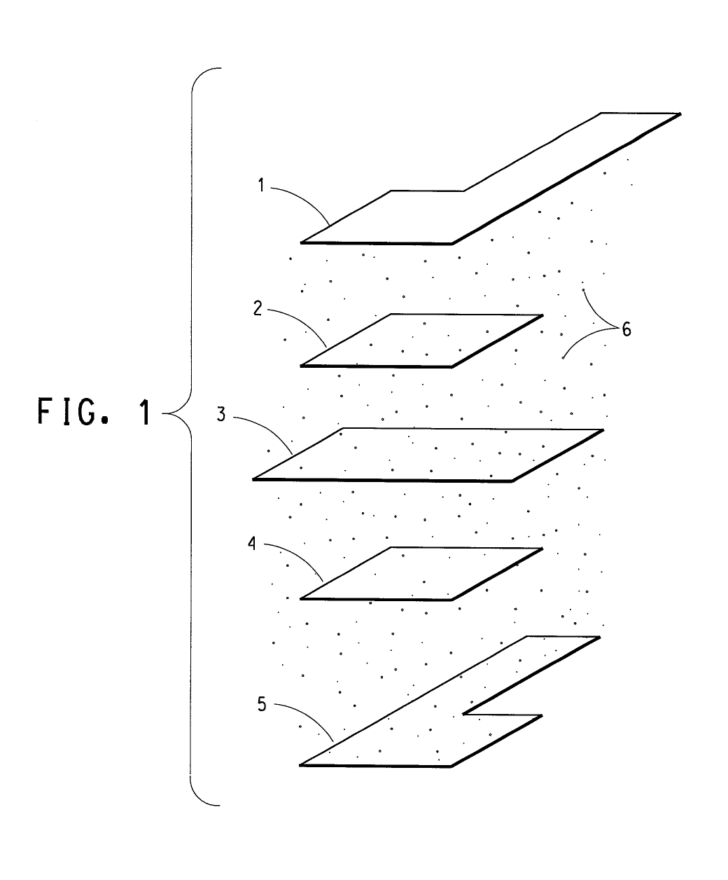

A preferred embodiment of the lithium ion battery of the present invention, shown in FIG. 1 comprises a cathode current collector in the form of an aluminum, 1, a cathode comprising a cathode active material such as a lithium transition metal oxide, 2, a separator such as polyvinylidene fluoride, an ionomer, or a porous polypropylene, 3, an anode comprising umnodified highly graphitized carbon having a reversible lithium intercalation capacity of at least 300 mAh/g, 4, an anode current collector such as a copper foil, 5, and an electrolyte solution, 6, comprising a mixture of aprotic solvents comprising propylene carbonate and ethylene carbonate and a lithium electrolyte salt such as LiPF6 or a lithium imide salt, and a fluorobenzene composition represented by the formula

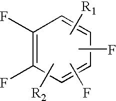

wherein R1 and R2 are independently hydrogen, halogen or other electron-withdrawing group, or an electron-donating group with the proviso that if R₁ is a non-halogen electron withdrawing group then R2 must be an electron-donating group. Preferably R1 is fluorine, and R2 is alkyl or alkoxy, most preferably R2 is methyl or methoxy.

### EXAMPLES

In the following specific embodiments, coin cells were fabricated on the laboratory bench scale. Each data point in the accompanying table represents an average of the number of identically prepared coin cells indicated. It was observed in the practice of the invention that approximately 9% of the coin cells failed catastrophically for reason which are believed to be associated with defects introduced during fabrication of the cell, typically a short circuit, and are not believed to be associated with the operability of the invention. It is further noted for each example the number of failed coin cells, from any cause, encountered. The failed cells are not averaged into the data.

To minimize failures, coin cells need to be made with great care because defects may be easily introduced often with catastrophic outcomes. All surfaces should be smooth; calendering is a useful technique for achieving a smooth surface. The electrodes should be uniform throughout. The separator should be uniform and absolutely free of pin-holes. When assembling the cell, all components need to be in register. Special care should be taken that no foreign object gets into the cell. Furthermore, any compression device such as a leaf spring utilized to push the components together into a tightly fitting package must not be so strong that it causes damage.

In the specific embodiments following, four different types of coin cells were formed and tested for each of the fluorobenzene derivatives of the invention. These were A) a cell comprising a LiCoO₂ cathode and a graphite anode made from D-PCG (Osaka Gas Co., Ltd, Osaka, Japan) synthetic graphite; B) a cell comprising a lithium metal anode and a graphite cathode made from D-PCG graphite; C) a cell comprising a LiCoO₂ cathode and a graphite anode made from LBG-80 (Superior Graphite Co., Bloomingdale, Ill., USA) natural graphite; and, D) a cell comprising a lithium metal anode and a graphite cathode made from LBG-80 graphite.

The cells were all otherwise assembled in an identical manner from identical components as described below.

10% binder solution

To a 250 mL bottle were added 20 g Kynar Flex® 2801 poly(vinylidene difluoride-co-hexafluoropropylene) (Atofina Chemicals North America, Philadelphia, Pa., USA) and 180 g acetone (Aldrich) and the mix was stirred with stirring bar at 600 rpm for 24 hours while the cap of the bottle was firmly capped.

D-PCG Graphite film

Into a blender cup were added 26.00 g D-PCG, 40.00 g 10% binder solution from above, 8.68 g Dibutylphthalate (DBP, Aldrich) and 1.30 g MMM super P (MMM S.A. Carbon, Brussels, Belgium). The slurry was mixed in such a speed that a nice vortex was maintained for 20 min for a good mixing. A thin film was obtained by casting the slurry on Mylar® polyester film (DuPont Company, Wilmington Del.) using a doctor blade. The gap of the blade was so adjusted that a coating weight of 9-13 mg/cm² was obtained after drying by removal of acetone. The film was cut into a 4.5 cm×5.5 cm piece and extracted with fresh diethyl ether (anhydrous, from Aldrich) three times for 30 min each. The film then was dried under vacuum (0.005 mBar) at 80° C. for at least 2 hours. Circular film specimens were punched out with a 12.7 mm diameter circular punch. The resulting samples weighed 9-13 mg.

LBG-80 Graphite film

Into a blender cup were added 26.00 g LBG-80, 40.00 g 10% binder solution from above, 8.68 g Dibutylphthalate (DBP, Aldrich) and 1.30 g MMM super P (MMM S.A. Carbon, Brussels, Belgium). The slurry was mixed in such a speed that a nice vortex was maintained for 20 min for a good mixing. A thin film was obtained by casting the slurry on Mylar sheet using Doctor blade. The gap of the blade was so adjusted that a coat weight of 8.6-12.3 mg/cm² was obtained after drying by removal of acetone. The film was cut into 4.5×5.5 cm² and extracted with fresh diethyl ether (anhydrous from Aldrich) three times for 30 min each extraction. The film then was dried under vacuum (0.005 mBar) at 80° C. for at least 2 hours. Circular film specimens were punched out with a 11.5 mm punch and the resulting specimens weighed 7-10 mg.

LiCoO₂ Cathode film

Into a blender cup were added 26.00 g Lithium Cobalt Oxide, LiCoO₂ (FMC Co., Gastonia, N.C., USA), 40.00 g 10% binder solution from above, 7.40 g Dibutylphthalate (DBP, Aldrich) and 2.6 g MMM super P (MMM S.A. Carbon, Brussels, Belgium). The slurry was mixed in such a speed that a nice vortex was maintained for 20 min for a good mixing. A thin film was obtained by casting the slurry on Mylar sheet using Doctor blade. The gap of the blade was so adjusted that a coat weight of 20.1-23.7 mg/cm² was obtained after drying by removal of acetone. The film was cut into 4.5×5.5 cm² and extracted with fresh diethyl ether (anhydrous from Aldrich) three times for 30 min each extraction. The film then was dried under vacuum (0.005 mBar) at 80° C. for at least 2 hours. Circular film specimens were punched out with a 11.5 mm diameter punch and the resulting specimens weighed 17-20 mg.

LiPF₆ Solution

Equal amounts of ethylene carbonate (EC) and propylene carbonate (PC) (both from EM Industries, Inc., Part of Merck KGaA, Darmstadt, Germany) were mixed to prepare a 1:1 wt mixture. Into a 100 mL volumetric flask were added 15.1900 g Lithium hexafluorophasphate, LiPF₆ (EM Industries, Inc., Part of Merck KGaA, Darmstadt, Germany) and 70 g the EC/PC mixture and the solution was stirred until all salt dissolved. Additional EC/PC was added to the 100 mL mark to obtain 1 M LiPF₆EC/PC electrolyte solution. This solution served as a master batch for the several experiments outlined hereinbelow. The solution was stored in an argon purged dry box.

All mixtures with the additives in Table 1 were made by combining 9.5 g of the master batch with 0.5 g of the additive in a glass vial in the dry box, and then shaking the mixture for less than a minute.

Coin cell

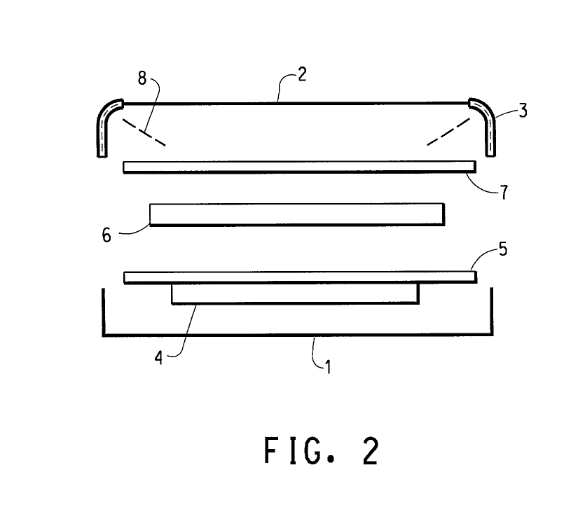

A typical type 2032 coin cell is shown in FIG. 2. The coin cell was formed by placing the components hereinabove described into the 20 mm diameter bottom section or “can”, 1, and sealing the cell by crimping onto the assembled components a lid, 2, electrically isolated from the can, 1, by a polypropylene gasket, 3. Before applying the lid, the positive graphite electrode, 4, was placed in the bottom of the can in electrical contact therewith. The separator, 5, a single layer of Celgard® 3501 microporous polypropylene (18.75 mm diameter, 24 microns thickness, 4.3 mg from Celanese Corp., N.C., USA), was positioned above the positive electrode and in direct physical contact therewith. The negative electrode, 6, was then placed in turn upon the separator, and a stainless steel spacer, 7, was placed on top of the negative electrode. To complete the package, a spring washer, 8, was disposed inside the lid so that when the lid is applied the spring will serve to compress the other components of the cell to provide intimate physical contact between respective facing surfaces. The coin cell crimper used was from Hohsen, Japan. Coin cells were 3.2 mm in thickness.

All operations of solution preparation and coin cell assembly were performed in an argon-purged dry box with a typical oxygen content of less than 1 ppm and of water of less than 5 ppm.

### Example 1A

Pentafluoroanisole (97+%, Aldrich) was dried over 0.3 Å molecular sieves for at least 48 hours. 0.5 g of the dried pentafluoroanisole was then combined with 9.5 g of the LiPF₆ solution to make a 5% solution of pentafluoroanisole.

The dried D-PCG electrode film (12.7 mm diameter, 62 microns thickness, 11.2 mg) and one piece of the Celgard® 3501 separator were soaked in the 5% pentafluoroanisole 1 M LiPF₆EC/PC (1:1 wt.) electrolyte solution in a closed vial in the dry-box for twenty minutes. Coin cells were made by employing the soaked D-PCG electrode as the positive electrode, the soaked Celgard® film as the separator, and a 12.7 mm diameter circle of Li metal foil of 0.22 mm in thickness and 18.1 mg as the negative electrode. The coin cell was sealed and discharged with constant current of 0.5 mA to a voltage of 0.01 V, at which point the voltage was held constant until the current dropped below 0.05 mA. The total capacity was thereby determined to be 3.83 mAh. The cell was then charged at a constant current of 0.50 mA to 1.10 V, and then the voltage was held constant at 1.10 V until the charging current dropped below 0.05 mA. The total recovered capacity was determined thereby to be 3.29 mAh. Reversible fraction was therefore 86% as listed for Example 1 in Table 1.

### Example 1B

The dried D-PCG electrode film (12.7 mm diameter, 60 microns thickness, 10.3 mg), one piece of the Celgard® 3501 separator and the dried LiCoO₂ electrode (11.5 mm diameter, 85 microns thickness, 18.5 mg) were soaked in the 5% pentafluoroanisole 1 M LiPF₆EC/PC (1:1 wt.) electrolyte solution in closed separated vials in the dry-box for twenty minutes each. The coin cell was made by employing the soaked LiCoO₂ electrode as the positive electrode, the soaked Celgard® film as the separator, and the D-PCG film as the negative electrode. The coin cell was sealed and charged with constant current of 0.50 mA to a voltage of 4.20 V, at which point the voltage was held constant until the current dropped below 0.05 mA. The total capacity was thereby determined to be 2.26 mAh. The cell was then discharged at a constant current of 0.50 mA to 2.80 V. The total recovered capacity was thereby determined to be 1.83 mAh. Reversible fraction was 81 % as shown for Example 3 in Table 1. The charge and discharge was repeated one more time and the cell was then charged with constant current of 0.50 mA to a voltage of 4.20 V, at which point the voltage was held constant until the current dropped below 0.005 mA. Then it was cycled (charged up to 4.20 volt with constant current 0.50 mA, at which point the voltage was held constant until the current dropped down to 0.05 mA, then discharged down to 2.80 V with constant current 0.50 mA) to 80% of its initial discharge capacity. The cycle life was recorded as 200 cycles as shown in Table 1.

### Example 1C

The dried LBG-80 electrode film (11.5 mm diameter, 103 microns thickness, 7.5 mg) and one piece of the Celgard® 3501 separator were soaked in the 5% pentafluoroanisole 1 M LiPF₆EC/PC (1:1 wt.) electrolyte solution in closed vial in the glove-box for twenty minutes. The coin cell was made by employing the soaked LBG-80 electrode as the positive electrode, the soaked Celgard® film as the separator, and a 12.7 mm diameter circle of Li metal foil 0.22 mm in thickness and 19.4 mg as the negative electrode. The coin cell was sealed and discharged with constant current of 0.50 mA to a voltage of 0.01 V, at which point the voltage was held constant until the current dropped below 0.05 mA. The total capacity was thereby determined to be 1.99 mAh. The cell was charged at a constant current of 0.50 mA to 1.10 V, and then the voltage was held constant at 1.10 V until the charging current dropped below 0.05 mA. The total recovered capacity was thereby determined to be 1.61 mAh. Reversible fraction was 81% as shown for Example 2 in Table 1.

### Example 1D

### LiCoO₂/5% pentafluoroanisole-electrolvte/LBG-80 coin cell

The dried LBG-80 electrode film (11.5 mm diameter, 119 microns thickness, 8.9 mg), one piece of the Celgard® 3501 separator and the dried LiCoO₂ electrode (11.5 mm diameter, 86 microns thickness, 18.6 mg) were soaked in the 5% pentafluoroanisole 1 M LiPF₆EC/PC (1:1 wt.) electrolyte solution in closed separate vials in the dry-box for twenty minutes each. The coin cell was made by employing the soaked LiCoO₂ electrode as the positive electrode, the soaked Celgard® film as the separator, and the LBG-80 film as the negative electrode. The coin cell was sealed and charged with constant current of 0.50 mA to a voltage of 4.20 V, at which point the voltage was held constant until the current dropped below 0.05 mA. The total capacity was thereby determined to be 2.30 mAh. The cell was then discharged at a constant current of 0.50 mA to 2.80 V. The total recovered capacity was thereby determined to be 1.88 mAh. Reversible fraction was 82%. The charge and discharge was repeated one more time and the cell was then charged with constant current of 0.50 mA to a voltage of 4.20 V, at which point the voltage was held constant until the current dropped below 0.005 mA. Then it was cycled (charged up to 4.20 volt with constant current 0.50 mA, at which point the voltage was held constant until the current dropped down to 0.05 mA, then discharged down to 2.80 V with constant current 0.50 mA) to 80% of its initial discharge capacity. The cycle life was 180 cycles.

### Examples 2A-8D

Cells in Examples 2-8 were prepared and tested using the same procedure and materials as in Examples 1A-1D except that the electrolyte solution contained the additive indicated in Table 1 instead of pentafluoroanisole.

In Examples 2A-2D trimethyl(pentafluorophenyl) silane (98%, Aldrich), which was dried over 3 Å molecular sieve for at least 48 hours, was mixed with 1 M LiPF₆EC/PC (1:1 wt.) electrolyte to make 5% additive-electrolyte solution.

In Examples 3A-3D pentafluorophenoxy trimethylsilane was prepared according to the method of B. Krumm et al, Inorg. Chem. 1997, 36(3), 366. The thus prepared pentafluorophenoxy trimethylsilane was dried over 3 Å molecular sieve for at least 48 hours followed by mixing with 1 M LiPF₆EC/PC (1:1 wt.) electrolyte to make 5% additive-electrolyte solution.

In Examples 4A-4D pentafluorostyrene (99%, Aldrich), which was dried over 3 Å molecular sieve for at least 48 hours, was mixed with 1 M LiPF₆EC/PC (1:1 wt.) electrolyte to make 5% additive-electrolyte solution.

In Example 5A-5D pentafluorotoluene (99%, Aldrich), which was dried over 3 Å molecular sieve for at least 48 hours, was mixed with 1 M LiPF₆EC/PC (1:1 wt.) electrolyte to make 5% additive-electrolyte solution.

In Examples 6A-6D 2,3,5,6-tetrafluoroanisole (97+%, Aldrich), which was dried over 3 Å molecular sieve for at least 48 hours, was mixed with 1 M LiPF₆EC/PC (1:1 wt.) electrolyte to make 5% additive-electrolyte solution.

In Examples 7A-7D, 1,2,3,5-tetrafluorobenzene (95%, Aldrich) was employed in place of the pentafluoroanisole. 1,2,3,5-tetrafluorobenzene was dried over 3 Å molecular sieve for at least 48 hours, and mixed with the 1 M LiPF₆EC/PC (1:1 wt.) electrolyte to make 5% additive-electrolyte solution. Results are shown in Table 1.

In Examples 8A-8D hexafluorobenzene (99%, Aldrich), which was dried over 3 Å molecular sieve for at least 48 hours, was mixed with 1 M LiPF₆EC/PC (1:1 wt.) electrolyte to make 5% additive-electrolyte solution.

### Comparative examples CE-1A TO CE-1D

The methods and materials of Example 1 were employed except that the 1 M LiPF₆EC/PC (1:1 wt.) electrolyte was employed without additive.

### Comparative Examples CE-2A TO CE-2D

The methods and materials of Example 1 were employed except that the electrolyte solution was replaced by a 1 M LiPF₆ solution in EC/DMC (2:1 wt.) electrolyte (LP-31 from EM Industries, Inc., Part of Merck KGaA, Darmstadt, Germany). The results are shown in Table 1.

### Comparative Examples CE-3A-3D

The methods and materials of Example 1 were employed except that octafluorotoluene was employed in place of the pentafluoroanisole in the 1 M LiPF6EC/PC electrolyte. The octafluorotoluene was from Aldrich, 98% which was dried over a 3 Å molecular sieve for at least 48 hours. This is representative of the art of Hamamoto et al, op. cit. The results are shown in Table 1.

TABLE 1
Summary of coin cell performance

| | | Exp. A | | Exp. B | | | Exp. C | | Exp. D | | |
|---|---|---|---|---|---|---|---|---|---|---|---|
| | ADDITIVE | rev. | #Tested | rev. | cycle | #Tested | rev. | #Tested | rev. | cycle | #Tested |
| Example | (5% by weight) | frac. (%) | (failed) | frac (%) | life | (failed) | frac. (%) | (failed) | frac (%) | life | (failed) |
| 1 | Pentafluoroanisole | 86 | NA | 81 | 200 | NA | 81 | NA | 82 | 180 | NA |
| 2 | Trimethyl (Pentafluorophenyl) silane | 86 | 2 (1) | 80 | 170 | 4 (3) | 0 | 4 (4) | 0 | NA | 2 (2) |
| 3 | Pentafluorophenoxy trimethylsilane | 85 | 2 (0) | 52 | 27 | 2 (0) | 69 | 3 (2) | 53 | 40 | 2 (0) |
| 4 | Pentafluorostyrene | 88 | 2 (0) | 61 | 14 | 4 (0) | 68 | 2 (0) | 61 | 15 | 2 (0) |
| 5 | Pentafluorotoluene | 73 | 2 (0) | 85 | 177 | 2 (0) | 87 | 4 (0) | 85 | 130 | 2 (0) |
| 6 | 2,3,5,6-tetrafluoroanisole | 88 | 2 (0) | 83 | 170 | 2 (0) | 79 | 2 (0) | 78 | 118 | 2 (0) |
| 7 | 1,2,3,5-tetrafluorobenzene | 86 | 2 (0) | 78 | 89 | 2 (0) | 64 | 2 (0) | 61 | 74 | 2 (0) |
| 8 | Hexafluorobenzene | 89 | 4 (1) | 82 | 83 | 2 (0) | 82 | 2 (0) | 83 | 163 | 2 (0) |
| CE-1 | 1 M LiPF6 EC/PC (1:1) | 20 | 6 (6) | 0 | NA | 4 (4) | 7 | 4 (4) | 0 | NA | 4 (4) |
| CE-2 | 1 M LiPF6 EC/DMC (2:1) | 92 | 4 (0) | 87 | 223 | 2 (0) | 90 | 2 (0) | 86 | 164 | 4 (2) |
| CE-3 | Octafluorotoluene | 81 | 2 (0) | 78 | 43 | 2 (0) | 62 | 2 (0) | 74 | 72 | 2 (0) |

What is claimed is:

1. A rechargeable lithium or lithium-ion electrochemical cell comprising a cathode; a lithium ion permeable separator; an anode comprising unmodified natural or synthetic graphite; and an electrolyte solution comprising propylene carbonate or butylene carbonate contacting said anode, the electrolyte solution further comprising an electrolyte salt comprising lithium cations, the electrolyte solution further comprising a fluorobenzene composition represented by the formula 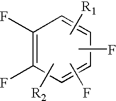
wherein R₁ and R₂ are independently hydrogen, halogen or other electron-withdrawing group, or an electron-donating group, with the proviso that if R₁ is a non-halogen electron withdrawing group then R₂ must be an electron-donating group, said electrolyte solution and said electrodes being in ionically conductive contact with each other.

2. The lithium or lithium-ion cell of claim 1 wherein the electrolyte solution comprises propylene carbonate.

3. The lithium or lithium-ion cell of claim 2 further comprising ethylene carbonate.

4. The lithium or lithium-ion cell of claim 3 wherein the concentration ratio of ethylene carbonate to propylene carbonate is in the range of 2:1 to 1:2 by weight.

5. The lithium or lithium-ion cell of claim 1 wherein R₁ is fluorine and R₂ is alkyl or alkoxy.

6. The lithium or lithium-ion cell of claim 5 wherein R₂ is methyl or methoxy.

7. The lithium or lithium-ion cell of claim 1 wherein the electrolyte salt is LiPF₆.

8. The lithium or lithium-ion cell of claim 4 wherein the electrolyte salt is LiPF₆, wherein is R₁ is fluorine and R₂ is alkyl or alkoxy, and wherein the concentration said fluorobenzene composition is 3-20% by weight of the electrolyte solution.

9. The lithium or lithium-ion cell of claim 8 wherein R₂ is methyl or methoxy.

10. The lithium or lithium-ion cell of claim 1 wherein the reversible capacity of the graphite is at least 300 mAh/g.

11. The lithium or lithium-ion cell of claim 1 wherein the graphite has an amorphos carbon content of less than 5% by weight.

12. The lithium or lithium-ion cell of claim 8 wherein the graphite has an amorphos carbon content of less than 5% by weight.
